(19) United States
(12) Patent Application Publication
(10) Pub. No.: US 2008/0212807 A1
(43) Pub. Date: Sep. 4, 2008

(54) Micromachined Acoustic Transducers

(75) Inventor: Yunlong Wang, Fremont, CA (US)

Correspondence Address: Venture Pacific Law, PC, 5201 Great America Parkway, Suite 270, Santa Clara, CA, 95054, US

(73) Assignee: GENERAL MEMS CORPORATION, Fremont, CA (US)

(21) Appl. No.: 12/117,724

(22) Filed: May 8, 2008

Related U.S. Application Data
(63) Continuation-in-part of application No. 11/160,071, filed on Jun. 8, 2005.

(51) Int. Cl. H04R 17/10

(52) U.S. Cl. 381/190; 310/322

(57) ABSTRACT

The present invention relates to an acoustic transducer that includes one or more capsules, side walls and a backing plate. Each capsule contains a cavity formed by the side walls and a plurality of film stacks. Each film stack has one or more membranes that can be a piezoelectric layer. Two or more of the film stacks that form the first cavity faces each other. A film stack and the backing plate face each other and form the wall of a second cavity. The transducers of this invention have a broadband response, can radiate sounds uni-directionally, and produce high quality sounds at low frequencies and at high intensities. They can be driven by AC signals. They can be fabricated using conventional integrated circuit manufacturing processes and therefore can be mass produced easily and inexpensively.

### FIELD OF INVENTION

The present invention relates to microelectromechanical microphones, and in particular, to microelectromechanical microphones using piezoelectric material.

### BACKGROUND

The micromachining technology that has led to the advancement of many micromachined acoustic devices has mostly focused on the development of microphones for converting acoustic signals to electrical signals that need further processing and reproduction. Some efforts have also been made to develop acoustic actuators that can operate in the ultrasonic range, such as capacitive micromachined ultrasonic transducers (CMUTs) that operate in the MHz or even higher frequency ranges. For example, U.S. patents with U.S. Pat. Nos. 5,619,476, 5,870,351, 5,894,452, and 6,493,288 describe the fabrication of capacitive-type ultrasonic transducers where membranes are supported above a substrate by insulative supports such as silicon nitride, silicon oxide, and polyamide. These supports engage the edges of each membrane. When voltage is applied between the substrate and a conductive film on the surface of the membrane, the membrane vibrates and emits sound waves.

Traditional micromachined capacitive ultrasonic transducers contain multiple small vacuum sealed cells, also referred to herein as CMUT cells. FIG. 1 is a diagram of a cross section of a CMUT cell that includes a membrane or diaphragm (1) coated with a metal electrode (2). The edges of the membrane are supported by an insulating support (4) that provides a space between the membrane and a conductive base (3). The interior volume (5) of the cell is evacuated. The geometry and the material of the membrane, together with the medium surrounding it, determine the mechanical response of the transducer. The CUMT cells, as seen in FIG. 2 as circular membranes (1) coated with a circular metal electrode (2) are interconnected with metal connectors (6).

Capacitive acoustic actuators typically provide better frequency response than traditional magnetically driven or piezoelectric actuators. For example, US patent publication no. 2005/0095814 A1 describes an example of a capacitive type acoustic speaker. Since these types of acoustic actuators rely on electrostatic actuation, they require a high bias voltage to generate the large enough diaphragm deflection needed to produce sound pressure levels adequate for end applications such as mobile phones. The high bias voltage needed to operate these actuators may pose safety hazards for end applications. In addition, the large diaphragm deflection can easily result in diaphragm fatigue, causing reliability concerns.

U.S. Pat. No. 6,552,469 discloses an acoustic actuator that is a solid state transducer. This transducer includes a micromachined electrostatic actuator made with silicon, a support brace placed above the actuator, and a membrane coupled to the support brace. The actuator is operatively coupled to the membrane. Theoretically, these transducers may act as receivers or microphones. However, in their manufacture and operation, these transducers do not provide any advantage over other devices made with traditional technology.

US patent publication no. 2005/0005429 discloses micromachined piezoelectric microspeakers that include a diaphragm and a plurality of contact pads. The diaphragm has a flat active area surrounded by a wrinkled non-active area. The contact pads for electrodes are situated over a wafer outside of the diaphragm. These piezoelectric microspeakers suffer from low output sound pressure level and poor frequency response when compared with traditional magnetically driven speakers.

Electro-acoustic transducer devices with piezoelectric materials generally perform substantially better at high frequencies than at low frequencies. Although applying electric fields to the driver elements with constrained piezoelectric membrane or ceramics elements in these devices can produce large forces, the resulting strain is relatively small. Therefore, it is difficult to obtain the large vibrational amplitudes needed for high intensity and low frequency sound with piezoelectric devices. In addition, the mechanical impedances of piezoelectric materials are generally closer to those of liquids and solids, rather than gases. This limits the energy transfer efficiency of piezoelectric electro-acoustic devices designed for use in air, such as loudspeakers.

A number of schemes have been devised introducing a mechanical advantage that would reduce the driving force and, in exchange, increase the force distance of a piezoelectric drive element. U.S. Pat. No. 5,196,755 provides a commercially available transducer that is illustrated in an exploded view in FIG. 3. A conductive metal disc (13) bonded to a thin layer or disc of piezoelectric ceramic material (12) is bonded to each side of a conductive metal ring (16) with a flexible adhesive layer (14) such that the metal discs and the metal ring is sandwiched between the piezoelectric ceramic material. In FIG. 3, the lower layer of the piezoelectric ceramic material is not visible. The conductive metal disc and the conductive metal ring can be made of brass. The rigid metal ring or support (16) need not be completely annular. In addition, the metal discs (13) may be in the form of plates that are not completely circular in shape. When an electric voltage is applied between the surfaces of the thin ceramic discs, the thickness as well as the radius of the disc can change. The relatively large forces of expansion and contraction that are produced are transferred to the surface of the metal disc that is bonded to the piezoelectric ceramic disc such that the metal disc bows up in the center when the piezoelectric ceramic disc expands, and bows down when the ceramic disc contracts. This transducer is also known as a transflextural piezoelectric element.

Although the low frequency performance of this transducer is superior to other conventional piezoelectric drive arrangements, the intensity of sound that can be radiated is limited. Moreover, for these transducers, the directionality of the sound can not be controlled; their radiating area is relatively small; and, their bandwidth is relatively narrow. Impedance mismatches render this type of element unsuitable for use in air. When used in ordinary loudspeakers, these transducers are expensive to manufacture and their enclosures difficult to design. It is also difficult to eliminate the effect of cancellation between positive and negative pressures at low frequencies where the wavelengths generated are greater than the size of the enclosure.

FIG. 4 illustrates a device that contains multiple transducers or driver elements such as those illustrated in FIG. 3. These driver elements (11) are potted in a flexible layer (17) a few millimeters thick to form an electro-acoustic transducer panel. The properties, thickness, and curing procedure of the potting material are adjusted to obtain the desired damping of the vibrating capsules and the frequency response of the device. These panels can be used underwater and in corrosive environments as the potting materials are water resistant or water proof to protect the driver elements from moisture and other contaminants.

This panel device has many of drawbacks. Its size is relatively large. The radiation of sound from such a panel is in two opposite directions. Although directionality of the radiation can be achieved by phasing the individual transducer elements, radiation can also occur at the back of the panel because of the symmetrical design of the panel. In most cases, this radiation is a noise source that needs to be suppressed. Moreover, the manufacturing process for this type of device usually requires the potting of organic materials and is difficult to control. Therefore, it is difficult to maintain the quality of this device during manufacturing. In addition, this transducer panel can not withstand high re-flow temperature, a necessary condition for automatic assembly.

For acoustic actuators that operate in the audio frequency band, it is essential that the actuators have the ability to move large volumes of air in order to generate an adequately large sound pressure level. This is especially true in the low frequency range where even larger diaphragm movements are needed. However, for micromachined devices, the diaphragm movement is typically limited to a few microns. Therefore, mechanisms to acoustically amplify the small sounds generated by these micromachined devices are needed to meet the requirements of many end applications.

Due to the limitations of the prior art, it is therefore desirable to have transducers that can produce high quality and high intensity sounds and that can be mass produced easily and inexpensively.

### SUMMARY OF THE INVENTION

An object of this invention is to provide transducers that produce high quality sounds at low frequencies and at high intensities.

Another object of this invention is to provide transducers that can radiate sounds uni-directionally.

Another object of this invention is to provide transducers that can be driven by AC signals.

Another object of this invention is to provide transducers that can be mass produced easily and inexpensively.

Another object of this invention is to provide transducers that have a broadband response.

The present invention relates to acoustic transducers that include one or more capsules, side walls and a backing plate. Each capsule contains a cavity formed by side walls and a plurality of film stacks. Each film stack has one or more membranes that can be a piezoelectric layer. Two or more of the film stacks that form the first cavity face each other. A film stack and the backing plate face each other and form the wall of a second cavity.

An advantage of the transducers of this invention is that they can produce high quality sounds at low frequencies and at high intensities.

Another advantage of the transducers of this invention is that they can radiate sounds uni-directionally.

Another advantage of the transducers of this invention is that they can be driven by AC signals.

Another advantage of the transducers of this invention is that they can be micromachined using conventional integrated circuit manufacturing processes and therefore can be mass produced easily and inexpensively.

Another advantage of the transducers of this invention is that they have a broadband response.

### DESCRIPTION OF DRAWINGS

The foregoing and other objects, aspects and advantages of the invention will be better understood from the following detailed description of the preferred embodiments of this invention when taken in conjunction with the accompanying drawings in which:

FIG. 1 is a cross-sectional view of a typical CMUT cell of the prior art.

FIG. 2 is diagram of an array of CMUT cells in a traditional CMUT microphone of the prior art.

FIG. 3 is an exploded view of a piezoelectric driver element of the prior art.

FIG. 4 is a side view of an electro-acoustic transducer panel using the piezoelectric driver element of FIG. 3.

FIG. 5 is a cross-sectional view of an acoustic transducer that is a preferred embodiment of the present invention.

FIG. 6 is a top view of an acoustic transducer that is a preferred embodiment of the present invention.

FIG. 7 is top view of a scalable transducer panel that is a preferred embodiment of the present invention.

FIG. 8 is an illustration of a cross-sectional view of the oscillation in an acoustic transducer that is a preferred embodiment of the present invention.

FIG. 9 is an illustration of the acoustic radiation from an acoustic transducer that is a preferred embodiment of the present invention.

FIG. 10 is an illustration of the mechanical equivalent of an acoustic transducer that is an embodiment of the present invention.

FIG. 11 is a cross-sectional view of an acoustic transducer that is another preferred embodiment of the present invention.

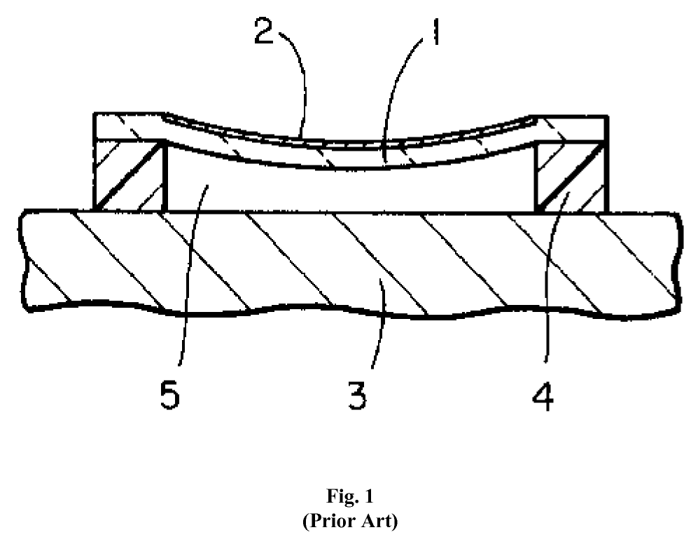

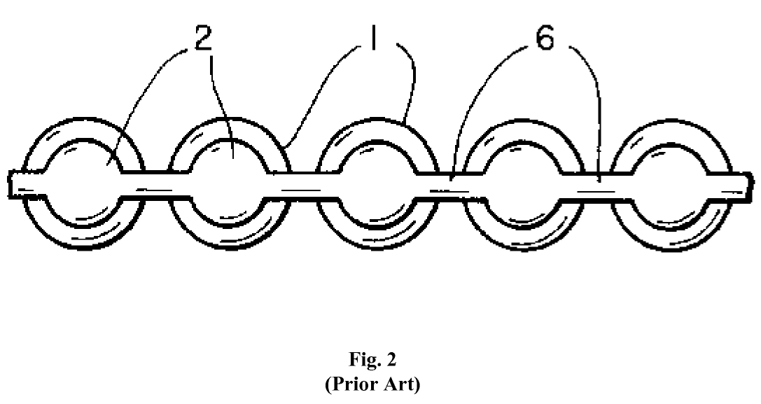

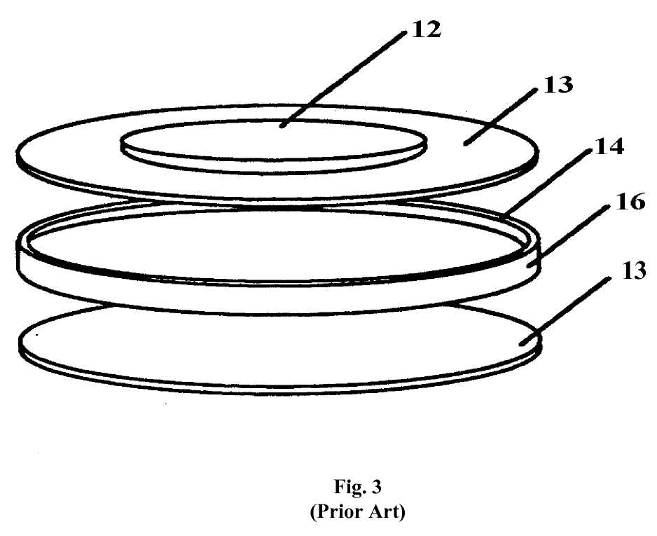

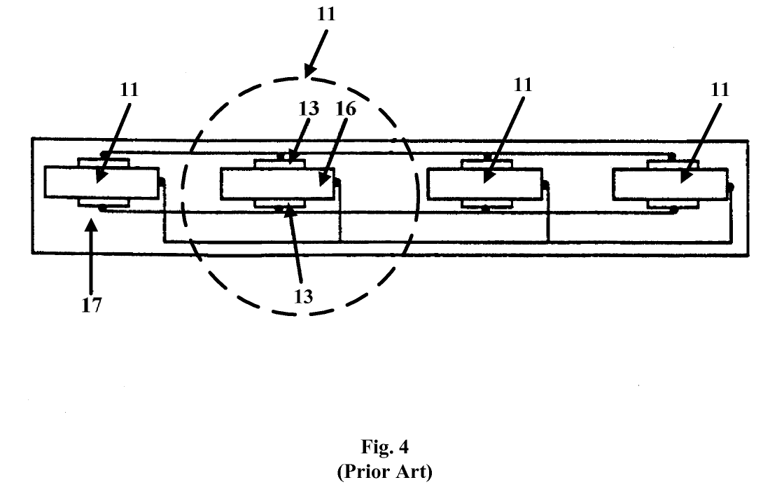

The following lists the numbers and parts of acoustic transducers in the figures herein. Not all parts listed below are in each preferred embodiment.
20 capsule
21 bottom conductor of film stack
22 piezoelectric layer of film stack
23 top conductor of film stack
24 inner side walls
25 film stack
26 cavity (first)
27 outer side wall
28 acoustic passages
29 cavity (second)
30 piers
31 backing plate
32 top wires
33 bottom wires
61 middle conductor of film stack

### DETAILED DESCRIPTION OF THE PREFERRED EMBODIMENTS

presently preferred embodiments provide transducers for sound generation and n that may contain one or more capsules arranged in a scalable array, in either one or two dimensions. In certain preferred embodiments, the capsules may be sealed. Each capsule may form an acoustic monopole. For example, each capsule may contain a pair of film stacks that faces each other and side walls such that the film stacks and the side walls form a cavity. Each film stack may contain one or more layers or material of which at least one is a membrane that may be a piezoelectric layer. Some of these layers of material may be layers of conducting material, referred herein as conductors. Preferably, the piezoelectric layer is sandwiched between the conducting layers. The surface of the film stack that is substantially aligned with the surfaces of said one of more layers of material is referred to herein as the face of the film stack. In the preferred embodiments, the film stacks containing the piezoelectric layers are placed on opposite sides of the cavity such that their faces are facing each other and they can move in phase with each other when driven.

In addition, the capsules are placed a certain distance away from a backing plate such that a second cavity is formed by one or more of the film stacks, the backing plate and one or more of the side walls or supporting piers. For example, in some preferred embodiments, the supporting piers separate the film stack from the backing plate forming the second cavity. The backing plate, if it is placed such that its surface is facing one or more of the film stacks, allows the sound to be reflected from the backing plate such that all sounds may be reflected in one direction. Holes are provided for the second cavity to equalize the pressure inside this cavity and provide passage for acoustic sound radiation from the second cavity.

The following embodiments further describe this invention.

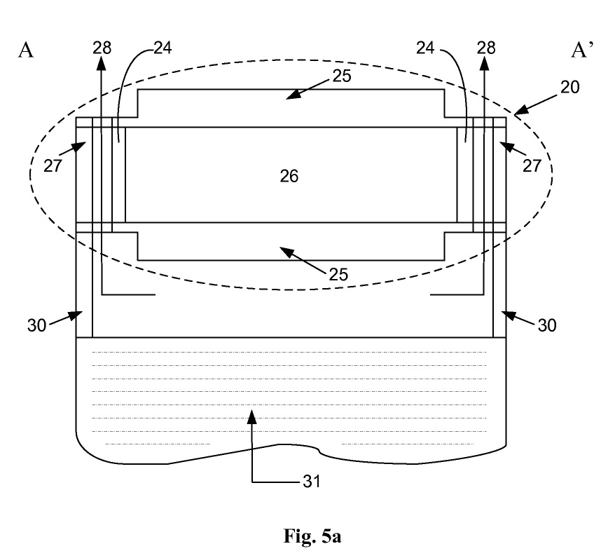

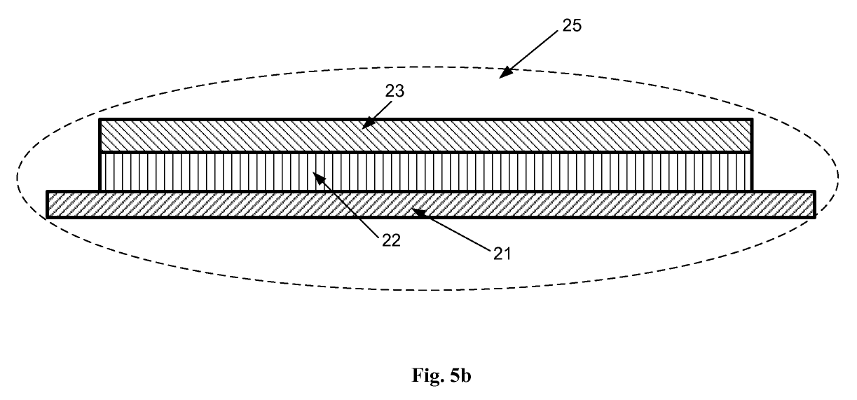

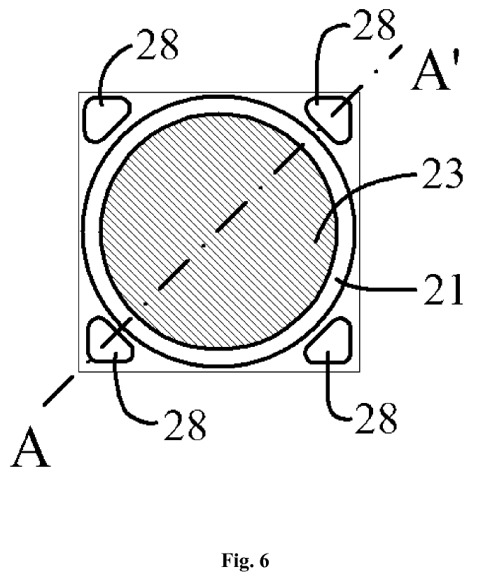

FIG. 5a illustrates a cross section of a micromachined acoustic transducer that is a preferred embodiment of the present invention. FIG. 5a is an AA′ cross section of the transducer whose top view is shown in FIG. 6. This transducer can include a capsule (20) that is supported on a backing plate (31) by piers (30). The capsule has an enclosed and sealed cavity (26) formed by two sets of film stacks (25) facing each other and two inner side walls (24). The cavity (26) may trap air, nitrogen, or other gaseous fluids. The inner side walls (24) and outer side walls (27) of the capsule form acoustic passages (28). The backing plate (31) and piers (30), together with the lower film stack form a second cavity (29).

One of the structures of a film stack (25) in a preferred embodiment is illustrated in FIG. 5b. Each film stack includes a piezoelectric layer (22) sandwiched between a bottom conductor (21) and a top conductor (23). The piezoelectric layer (22) can be made with silicon nitride, aluminum nitride, zinc oxide or other piezoelectric material that can be micromachined. The properties and thickness of conductors (21) and (23) and the piezoelectric layer (22) can be chosen with consideration of the materials used to obtain the desired damping of the vibrating capsule and to control the frequency response.

FIG. 6 is a top view of the micromachined acoustic transducer shown in FIGS. 5a and 5b where the top conductor (23) and the rim of the bottom conductor (21) of the top film stack are visible. The acoustic passages (28) may be arranged at the four corners of the micromachined acoustic transducer. The shape of these acoustic passages (28) may also vary. For example, they may be triangular, square, or any other shape.

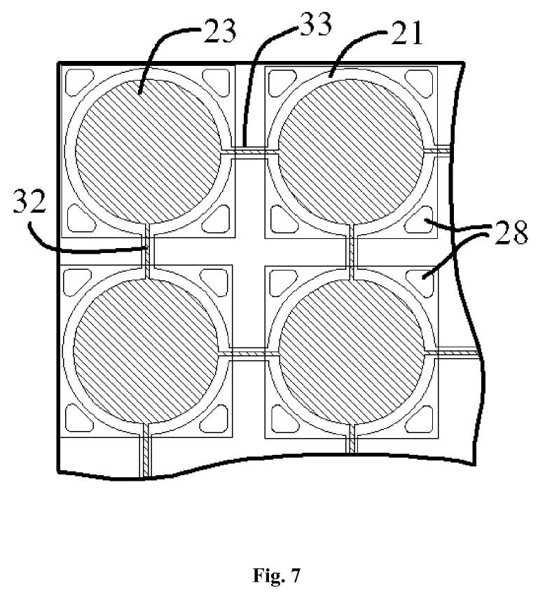

The transducer illustrated in FIGS. 5a, 5b and 6 can operate as a single element. Alternatively, multiple capsules can also be attached to form a panel. FIG. 7 is a diagram of a top view of such a panel of four capsules arranged in a two-dimensional scalable pattern. Each capsule with its top conductor (23) and the rim of its bottom conductor (21) of its top film stack visible is connected to its neighboring capsules by top wires (32) and bottom wires (33). Any number of these capsules can be connected to form a scalable two-dimensional panel. The capsules in this configuration can share one or more second cavities. For example, two capsules can share a single second cavity; four capsules can share a single second cavity; or all of the capsules can share the same second cavity. Furthermore, the capsules can also share one or more backing plates. For example, two capsules can share a single backing plate; four capsules can share a single backing plate; or all of the capsules can share the same backing plate. Different effects can be further achieved when the sharing of the backing plates and second cavities are varied to generate different acoustic effects. For example, a 9-capsule in a two dimensional array (1 center capsule in the middle and 8 capsules surrounding the center capsule) can be configured where the center capsule having its own second cavity and backing plate while the other 8 capsules sharing the same second cavity and backing plate.

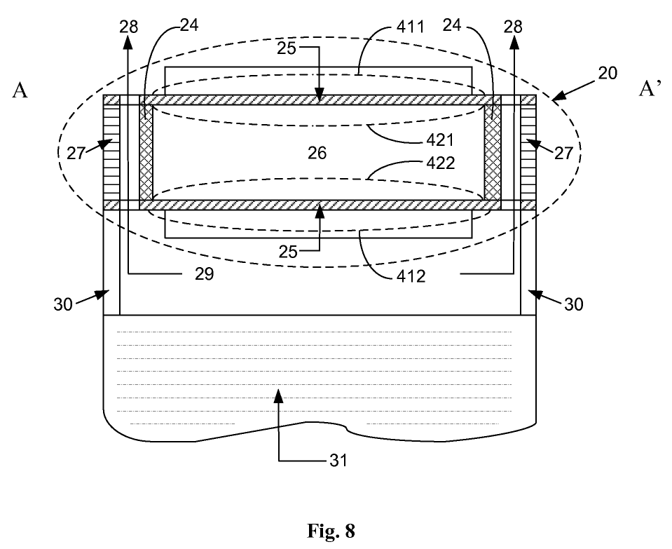

The two film stacks in a capsule act as the top and bottom electrode. When the micromachined acoustic transducer is used as a sound transmitter, the film stacks (25) are driven by the piezoelectric force such that it mechanically oscillates. FIG. 8 illustrates this oscillation with the AA′ cross sectional view of a transducer whose top view may be illustrated by FIG. 6. The polarity of electric signals may be arranged such that when the top film stack buckles down to position 421, the bottom film stack buckles up to position 422. When the polarity of applied electric signal reverses, the top film stack (25) buckles up to position (411) and the bottom film stack buckles down to position 412. As the electric signal alternates, the top film stack will oscillate between positions 411 and 421 while the bottom film stack 25 will oscillate between positions 412 and 422.

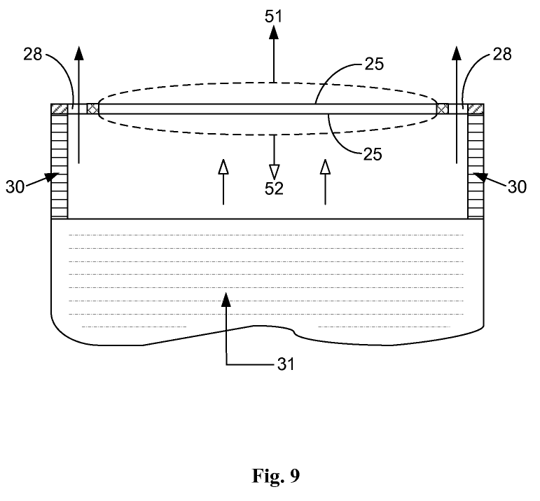

As the film stacks oscillate, they move the surrounding air resulting in the radiation of sound as illustrated by a cross-sectional view of the transducer in FIG. 9. The top film stack (25) will radiate the sound in the forward direction (51) while the bottom film stack (25) will radiate the sound in the backward direction (52). The backward radiated sound from the bottom film stack (25) will then be reflected back by the backing plate (31). After reversing the direction as a result of the reflection, this part of sound energy may then pass through the acoustic passages (28) and radiate in the forward direction (51) along with the sound energy radiated from top film stack (25). The radiation from the top film stack in FIG. 9 is indicated by a solid arrow while the radiation from the bottom film stack is indicated by a hollow arrow.

In the preferred embodiments, the acoustic properties of the backing plate (31) may be chosen such all the backward radiated sound from bottom film stack are completely reflected. For example, the backing plate can be made from quartz, single crystal silicon, or metals such as steel, or aluminum.

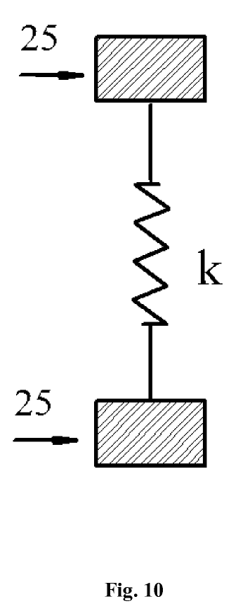

The capsule in the micromachined acoustic transducers that are the preferred embodiments essentially functions an acoustic monopole. For example, the top and bottom film stacks of the embodiment described herein can be analogized to the two ends of a spring-mass system illustrated in FIG. 10. The trapped air in the cavity (26) of capsule (20) behaves like a spring with spring constant K. The oscillation of the top and bottom film stacks, equivalent to the contraction and relaxation of the spring, provide added deflection amplitude to the film stacks and generating increased output sound power.

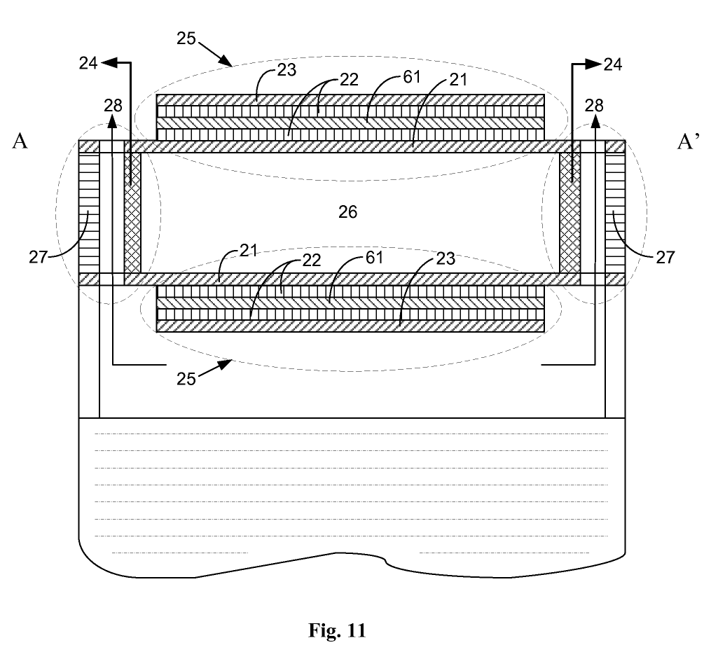

In other preferred embodiments of present invention, the top and bottom film stacks can be made with multiple layers of piezoelectric electric layers where each piezoelectric layer is sandwiched between conducting layers. FIG. 11 is an example of an A-A′ cross section of such a film stack for a transducer illustrated in FIGS. 5a and 6 that is another preferred embodiment. Each film stack has two piezoelectric layers (22). One piezoelectric layer is sandwiched between the bottom conductor (21) and a middle conductor (61) while the second piezoelectric layer is sandwiched between the middle conductor (61) and the top conductor (23).

Micromachined two-dimensional transducer array panel have many advantages over existing one-dimensional designs. They have piezoelectric actuation such that AC signals can drive the devices. They can be micromachined in two-dimensional arrays using conventional integrated circuit manufacturing processes. The dimension of these devices can be optimized for specific materials. The design of the preferred embodiments enables the device to have broadband response thus eliminating the need to utilize devices with different diameter on the same die. The two-dimensional array panel can also be focused by appropriately addressing and driving each capsule in the array with different time delay such that the sound generated from the panel can be focused in a spatial location.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. An acoustic transducer, comprising:
a capsule having a first cavity formed by one or more side walls and a plurality of film stacks; and
a backing plate; and
one or more piers;
wherein said backing plate and said piers form a second cavity and wherein said film stack has a membrane.

2. The transducer of claim 1 wherein said membrane is a piezoelectric layer.

3. The transducer of claim 1 wherein said membrane is sandwiched between two conducting layers.

4. The transducer of claim 2 wherein said membrane is sandwiched between two conducting layers.

5. The transducer of claim 1 wherein said inner side wall and said outer side wall form one or more acoustic passages.

6. The transducer of claim 1 wherein said backing plate having a high acoustic impedance.

7. The transducer of claim 1 wherein said film stack having a plurality of conducting layers and said membrane is sandwiched between two conducting layers.

8. The transducer of claim 2 wherein said film stack having a plurality of conducting layers and said membrane is sandwiched between two conducting layers

9. The transducer of claim 1 wherein said first cavity having gaseous fluids.

10. The transducer of claim 1 wherein each of said film stacks having a plurality of said membranes.

11. The transducer of claim 10 wherein said membrane is a piezoelectric layer.

12. The transducer of claim 11 wherein said film stack having a plurality of conducting layers and the plurality of said membranes are sandwiched between a plurality of conducting layers.

13. The transducer of claim 1 wherein said transducer having a plurality of said capsules.

14. The transducer of claim 13 wherein said plurality of said capsules share one or more second cavities.

15. The transducer of claim 14 wherein said plurality of said capsules share one or more backing plates.

16. The transducer of claim 13 wherein said plurality of said capsules share one or more backing plates.

17. The transducer of claim 1 wherein
said backing plate having a surface;
said film stacks forming said first cavity face each other; and
said backing plate faces one of said film stacks.

18. The transducer of claim 17 wherein said backing plate having a high acoustic impedance.

19. An acoustic transducer, comprising:
a capsule having a first cavity formed by one or more side walls and a plurality of film stacks, wherein said film stacks face each other; and
a backing plate having a high acoustic impedance, wherein said backing plate faces one of said film stacks; and
one or more piers;
wherein said backing plate and said piers form a second cavity; wherein said film stack has one or more piezoelectric layers sandwiched between two or more conducting layers; and wherein said inner side wall and said outer side wall form one or more acoustic passages.

20. The transducer of claim 19 wherein said first cavity having gaseous fluids.

21. The transducer of claim 19 wherein said transducer having a plurality of said capsules and said plurality of said capsules share one or more second cavities.

22. The transducer of claim 21 wherein said plurality of said capsules share one or more backing plates.

23. An acoustic transducer, comprising:
one or more capsules, each of the capsules having:
a first cavity formed by one or more side walls and a plurality of film stacks, wherein said film stacks face each other; and
a backing plate having a high acoustic impedance, wherein said backing plate faces one of said film stacks; and
one or more piers;
wherein said backing plate and said piers form a second cavity; wherein each of the film stacks has one or more piezoelectric layers sandwiched between two or more conducting layers; wherein said inner side wall and said outer side wall form one or more acoustic passages; wherein said one or more capsules share one or more second cavities; and wherein said one or more capsules share one or more backing plates.
